(19) United States
(12) Patent Application Publication
(10) Pub. No.: US 2006/0016788 A1
(43) Pub. Date: Jan. 26, 2006

(54) Method for welding employing current

(76) Inventors: Ryan J. Suhre, Linden, MI (US); Venkatasubramanian Ananthanarayanan, Beavercreek, OH (US); Johnny R. Gentry, Bellbrook, OH (US); Andrzej Marian Pawlak, Rochester Hills, MI (US); James M. Payne, Grandblanc, MI (US); Deepak K. Sharma, Troy, MI (US); Kenneth E. Johnson, South Lyon, MI (US)

Correspondence Address: Delphi Technologies, Inc.;M/C 480-410-202, P.O. Box 5052, Troy, MI, 48007-5052, US

(21) Appl. No.: 11/176,978

(22) Filed: Jul. 7, 2005

Related U.S. Application Data
(60) Provisional application No. 60/590,654, filed on Jul. 23, 2004.

(51) Int. Cl. B23K 11/00

(52) U.S. Cl. 219/59.1; 219/117.1

(57) ABSTRACT

One method of the invention is for welding and includes obtaining first and second members each including an extrusion having a through hole and includes obtaining first and second electrodes each having an electrode portion. The second member is positioned to have the second extrusion nest in the first through hole against the first extrusion. The first electrode is positioned to have the first-electrode portion nest in the second through hole against the inside of the second extrusion. The second electrode is positioned to have the second-electrode portion contact the outside of the first extrusion. Another method of the invention is for welding and includes obtaining a tube having an end form and a member having first and second portions. The tube and the member are positioned with the end form contacting the first portion while leaving a recess between the end form and the second portion.

### CROSS REFERENCE TO RELATED APPLICATIONS

The present application claims priority of U.S. Provisional Application No. 60/590,654 filed Jul. 23, 2004.

### TECHNICAL FIELD

The present invention relates generally to metallurgy, and more particularly to a method for welding employing current.

### BACKGROUND OF THE INVENTION

Conventional methods for welding a tube to another tube or for welding a bracket or plate to a tube include gas metal arc welding. Gas metal arc welding uses a consumable metal wire as one electrode and the parts as another electrode, and moves the consumable metal wire (or the parts) to draw an arc and weld the parts together. The welding is accompanied by a gas (such as a mixture of argon and carbon dioxide) to prevent oxidation and stabilize the arc. Such gas metal arc welding is well known. In a conventional gas metal arc welding technique, solid metal wire or metal core wire (i.e., an annular-solid wire whose core is filled with metal powder such as a mixture of metal, alloy and/or oxide powders) is used with the wire typically at a positive electrical welding potential and with the parts electrically grounded. The welding arc creates a molten weld puddle which results in the welding together of the parts. Gas metal arc welding requires expensive welding equipment, the molten weld puddle tends to flow away from the joint area (depending on the joint position with respect to gravity) resulting in welds of inconsistent quality, and the process requires a long cycle time between welds.

Conventional methods for attaching parts together also include friction welding. To join two tubes together end to end, one of the tubes is rotated about its longitudinal axis, and the tube ends are pressed together, wherein friction causes heating of the ends creating the weld. To join a tube to a plate, the tube is rotated about its longitudinal axis, and the tube end and the plate are pressed together, wherein friction causes heating creating the weld. Friction welding requires expensive welding equipment, and the process requires a long cycle time between welds. Friction welding is not easily applicable to thin-walled tubes because they do not retain their shapes well under heat and pressure. It is noted that laser and electron-beam welding for the above joints also need expensive equipment and an improved method for welding employing current.

What is needed is an improved method for welding.

### SUMMARY OF THE INVENTION

A first method of the invention is for welding and includes steps a) through h). Step a) includes obtaining a first member including a first extrusion having a first through hole. Step b) includes obtaining a second member having a second extrusion having a second through hole. Step c) includes obtaining a first electrode having a first-electrode portion. Step d) includes obtaining a second electrode having a second-electrode portion. Step e) includes positioning the second member to have the second extrusion nest in the first through hole against the first extrusion. Step f) includes positioning the first electrode to have the first-electrode portion nest in the second through hole against the inside of the second extrusion. Step g) includes positioning the second electrode to have the second-electrode portion contact the outside of the first extrusion. Step h) includes creating a welding current path through the first electrode, the second extrusion, the first extrusion, and the second electrode to create a weld zone which includes at least some of the first and second extrusions.

A second method of the invention is for welding and includes steps a) through g). Step a) includes obtaining a tube including a sidewall having a first extrusion having a first through hole. Step b) includes obtaining a member having a second extrusion having a second through hole. Step c) includes obtaining a first electrode having a first-electrode portion. Step d) includes obtaining a second electrode having a second-electrode portion. Step e) includes positioning the member from outside the tube to have the second extrusion nest in the first through hole against the first extrusion. Step f) includes positioning the first electrode from outside the tube to have the first-electrode portion nest in the second through hole against the inside of the second extrusion. Step g) includes positioning the second electrode to have the second-electrode portion contact the outside of the first extrusion from inside the tube. Step h) includes creating a welding current path through the first electrode, the second extrusion, the first extrusion, and the second electrode to create a weld zone which includes at least some of the first and second extrusions.

A third method of the invention is for welding and includes steps a) through d). Step a) includes obtaining a first tube having a first end form. Step b) includes obtaining a member having first and second portions. Step c) includes positioning the first tube and the member with the first end form contacting the first portion while leaving a first recess between the first end form and the second portion. Step d) includes creating a welding current path through the first end form and the member and relatively moving the first end form deformingly against the member to eliminate the first recess and create a weld zone which includes at least some of the first end form and at least some of the member.

A fourth method of the invention is for welding and includes steps a) through d). Step a) includes obtaining a first tube having an outwardly-scrolled-back first end form. Step b) includes obtaining a member having first and second portions. Step c) includes positioning the first tube and the member with the first end form contacting the first portion while leaving a first recess between the first end form and the second portion. Step d) includes creating a welding current path through the first end form and the member and relatively moving the first end form deformingly against the member to eliminate the first recess and create a weld zone which includes at least some of the first end form and at least some of the member.

Several benefits and advantages are derived from one or more of the methods of the invention. Welding using electric current is less expensive than gas metal arc welding or friction welding. Welding using electric current also has a shorter cycle time between welds than gas metal arc welding or friction welding. Deformation welding allows solid state welds of dissimilar materials without the formation of brittle intermetallic compounds.

### SUMMARY OF THE DRAWINGS

FIG. 1 is a schematic, side cross-sectional view of a tube and a bracket before positioning for welding;

FIG. 2 is a schematic, side cross-sectional view of the tube and the bracket of FIG. 1 and of two electrodes, wherein the bracket, tube, and electrodes are positioned for welding, and wherein the bracket is being welded to the tube;

FIG. 3 is a schematic, side cross-sectional view of two tubes and two welding electrodes positioned for welding together the two tubes, wherein each tube has an outwardly-scrolled-back end form;

FIG. 4 is a view, as in FIG. 3, but after the two tubes have been welded together and with the two welding electrodes removed;

FIG. 5 is a cutaway view of two tubes and two welding electrodes being brought into position for welding together the two tubes, with one tube having an outwardly-scrolled-back end form and with the other tube having an outwardly-transversely-flanged end form;

FIG. 6 is a cutaway view of two welding electrodes, a first tube including a sidewall having a through hole, and a second tube having an outwardly-transversely-folded end form being positioned for partial insertion into the through hole for welding to the first tube;

FIG. 7 is a cutaway view of two welding electrodes, a tube having an outwardly-scrolled-back end form, and an end cap plate positioned for welding to the end form;

FIG. 8 is a view, as in FIG. 7, but with the tube having an outwardly-transversely-flanged end form and with the end cap plate replaced with an end cap having a turned-in annular edge positioned for welding on top of the end form;

FIG. 9, is a view, as in FIG. 8, but with the outwardly-transversely-flanged end form replaced with an outwardly-transversely-folded end form; and

FIG. 10 is a view, as in FIG. 8, but with the edge of the end cap folded around the outwardly-transversely-flanged end form.

### DESCRIPTION OF THE PREFERRED EMBODIMENTS

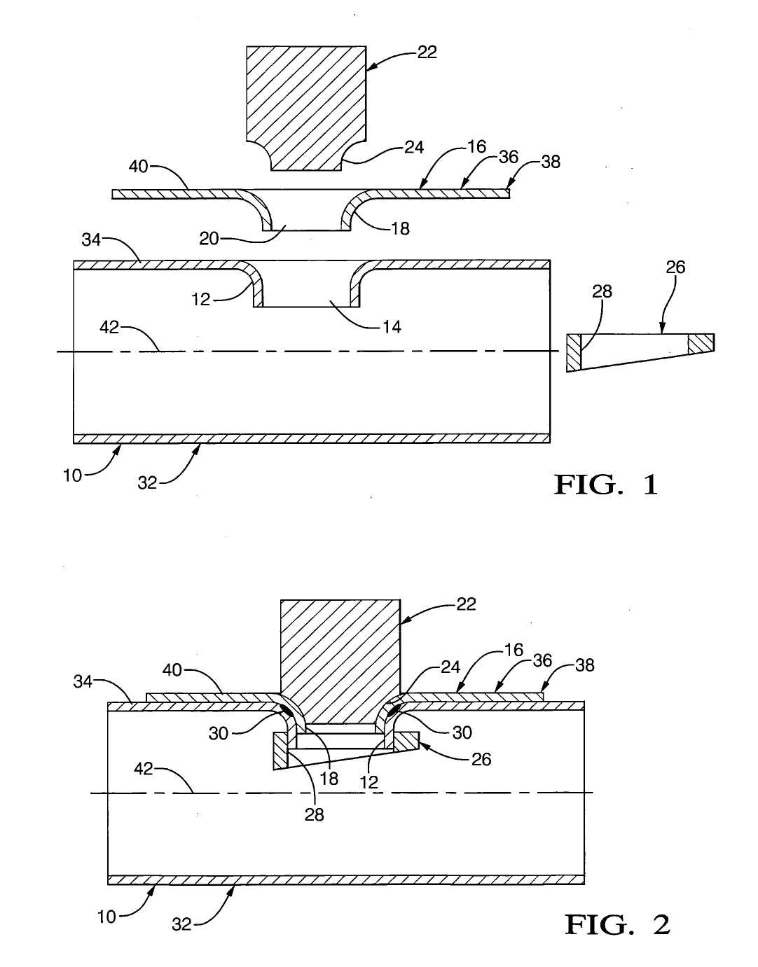

A first method of the invention is for welding together two members, wherein an embodiment of the members and an embodiment of two electrodes used during welding is shown in FIGS. 1-2. The first method includes steps a) through h). Step a) includes obtaining a first member 10 including a first extrusion 12 having a first through hole 14. Step b) includes obtaining a second member 16 having a second extrusion 18 having a second through hole 20. Step c) includes obtaining a first electrode 22 having a first-electrode portion 24. Step d) includes obtaining a second electrode 26 having a second-electrode portion 28. Step e) includes disposing the second member 16 to have the second extrusion 18 nest in the first through hole 14 against the first extrusion 12. Step f) includes disposing the first electrode 22 to have the first-electrode portion 24 nest in the second through hole 20 against the inside of the second extrusion 18. Step g) includes disposing the second electrode 26 to have the second-electrode portion 28 contact the outside of first extrusion 12. Step h) includes creating a welding current path through the first electrode 22, the second extrusion 18, the first extrusion 12, and the second electrode 26 to create a weld zone 30 which includes at least some of the first and second extrusions 12 and 18. In one enablement of the first method, step h) also includes relatively moving the first and second electrodes 22 and 26 to relatively move the first extrusion 12 deformingly against the second extrusion 18.

An “extrusion having a through hole” is a portion of a member which is raised above the adjoining surface, by whatever means, and which surrounds a through hole. Extrusions include, without limitation, a partial extrusion wherein the raised portion is raised to less than a perpendicular position from its unraised state and a full extrusion wherein the raised portion is raised to an angle substantially equal to ninety degrees from its unraised state.

In an alternate first method, step a) is replaced with the steps of obtaining a first member 10 and creating the first extrusion 12 in the first member 10, and step b) is replaced with the steps of obtaining a second member 16 and creating the second extrusion 18 in the second member 16.

In one construction of the first method, the second electrode 26 includes two electrode halves. Supports for the first and second electrodes 22 and 26 have been omitted from FIGS. 1-2 for clarity. In one construction, not shown, a sliding mechanism supports the second electrode 26, as can be understood by those skilled in the art. Other constructions are left to the artisan.

Referring again to FIGS. 1-2, a second method of the invention is for welding together two members (wherein one of the members is a tube) and includes steps a) to h). Step a) includes obtaining a tube 32 including a sidewall 34 having a first extrusion 12 having a first through hole 14. Step b) includes obtaining a member 36 having a second extrusion 18 having a second through hole 20. Step c) includes obtaining a first electrode 22 having a first-electrode portion 24. Step d) includes obtaining a second electrode 26 having a second-electrode portion 28. Step e) includes disposing the member 36 from outside the tube 32 to have the second extrusion 18 nest in the first through hole 14 against the first extrusion 12. Step f) includes disposing the first electrode 22 from outside the tube 32 to have the first-electrode portion 24 nest in the second through hole 20 against the inside of the second extrusion 18. Step g) includes disposing the second electrode 26 to have the second-electrode portion 28 contact the outside of the first extrusion 12 from inside the tube 32. Step h) includes creating a welding current path through the first electrode 22, the second extrusion 18, the first extrusion 12, and the second electrode 26 to create a weld zone 30 which includes at least some of the first and second extrusions 12 and 18. In one enablement of the second method, step h) also includes relatively moving the first and second electrodes 22 and 26 to relatively move the first extrusion 12 deformingly against the second extrusion 18.

In an alternate second method, step a) is replaced with the steps of obtaining a first member 10 and creating the first extrusion 12 in the first member 10, and step b) is replaced with the steps of obtaining a second member 16 and creating the second extrusion 18 in the second member 16.

In one construction of the second method, the tube 32 is a substantially rectangular tube. In the same or a different construction, the member 36 is a bracket 38 having a plate 40 and the second extrusion 18, and the second extrusion 18 extends substantially perpendicular from the plate. In the same or a different construction, the tube 32 has a centerline 42, and the first and second extrusions 12 and 18 are substantially coaxially aligned perpendicular to the centerline 42.

In one application of the second method, the member 36 is chosen from the group consisting of a bracket 38, a gusset, a hanger, a heat shield, and an impact shield. Other types of members 36 are left to the artisan.

In one employment of the second method, in step f) the first electrode portion 24 is disposed in full circumferential contact with the inside diameter of the second extrusion 18. In one variation, in step g) the second electrode portion 28 is disposed in full circumferential contact with the outside diameter of the first extrusion. In one variation, the weld zone 30 is an annular weld zone.

In one utilization of the second method, step h) is performed without the use of filler material. In one variation of the second method, the tube 32 and the member 36 are made of dissimilar (or similar) materials, and step h) heats at least some of the first and second extrusions 12 and 18 to a semi-fused state (creating a solid state weld). In a different variation, the tube 32 and the member 36 are made of similar materials, and step h) heats at least some of the first and second extrusions 12 and 18 to a fused state.

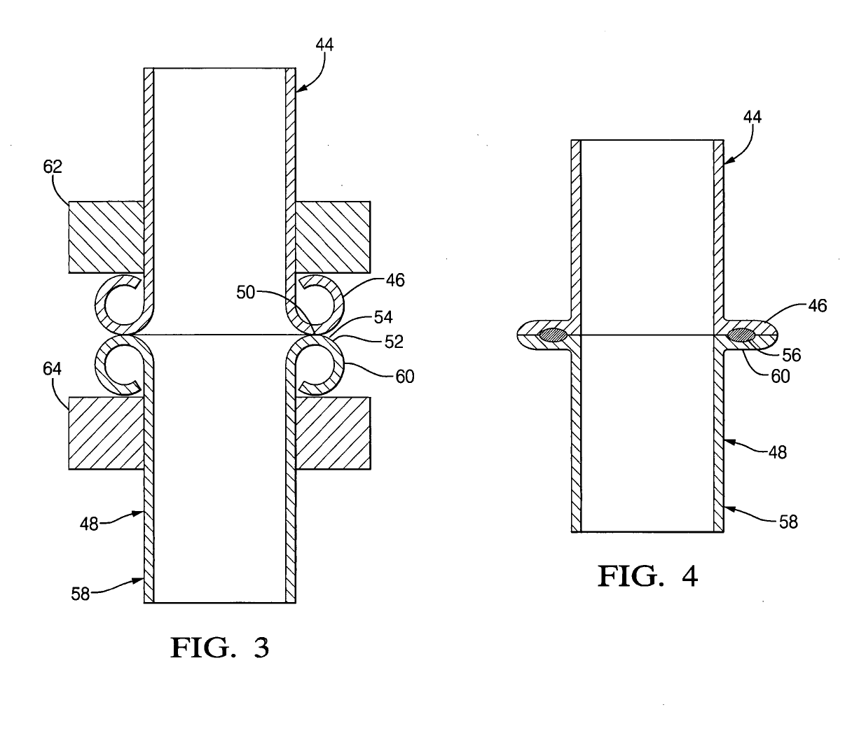

Referring to FIGS. 3-4, a third method of the invention is for welding and includes steps a) through d). Step a) includes obtaining a first tube 44 having a first end form 46. Step b) includes obtaining a member 48 having first and second portions 50 and 52. Step c) includes disposing the first tube 44 and the member 48 with the first end form 46 contacting the first portion 50 while leaving a first recess 54 between the first end form 46 and the second portion 52. Step d) includes creating a welding current path through the first end form 46 and the member 48 and relatively moving the first end form 46 deformingly against the member 48 to eliminate the first recess 54 and create a weld zone 56 which includes at least some of the first end form 46 and at least some of the member 48.

In an alternate third method, step a) is replaced with the steps of obtaining a first tube 44 and creating the first end form 46 in the first tube 44. An end form of a tube is an end portion of a tube which has a different cross-sectional shape (with the cross section taken by a cutting plane which is aligned perpendicular to the tube's centerline) from that of the tube before the end portion.

In one utilization of the third method, deformingly eliminating the first recess 54 brings the atoms of the deformingly contacting portions of the first end form 46 and the member 48 into close contact for an improved solid state weld.

In one enablement of the third method, the member 48 is chosen from the group consisting of a second tube having a second end form for contacting the first end form, a second tube including a sidewall having a through hole for receiving a portion of the first end form, a plate, an end cap having an annular scrolled edge, and the first end form 46 is chosen from the group consisting of an outwardly-transversely-flanged first end form, and an outwardly-transversely folded first end form.

Referring again to FIGS. 3-4, a fourth method of the invention is for welding and includes steps a) through d). Step a) includes obtaining a first tube 44 including a first end form 46 having an outwardly-scrolled-back shape. Step b) includes obtaining a member 48 having first and second portions 50 and 52. Step c) includes disposing the first tube 44 and the member 48 with the first end form 58 contacting the first portion 50 while leaving a first recess 54 between the first end form 58 and the second portion 52. Step d) includes creating a welding current path through the outwardly-scrolled-back first end form 46 and the member 48 and relatively moving the first end form 46 deformingly against the member 48 to eliminate the first recess 54 and create a weld zone 56 which includes at least some of the first end form 46 and at least some of the member 48.

In an alternate fourth method, step a) is replaced with the steps of obtaining a first tube 44 and creating in the first tube 44 a first end form 46 having an outwardly-scrolled-back shape.

In one enablement of the fourth method, the member 48 is chosen from the group consisting of a second tube having a second end form for contacting the first end form, a second tube including a sidewall having a through hole for receiving a portion of the first end form, a plate, an end cap having an annular scrolled edge.

In one employment of the fourth method, the member 48 is a second tube 58 having a second end form 60, and the first and second portions 50 and 52 are first and second portions of the second end form 60. In one variation, step d) creates a welding current path through the first and second end forms 46 and 60 and relatively moves the first end form 46 deformingly against the second end form 60 to eliminate the first recess 54 and create the weld zone 56, wherein the weld zone 56 includes at least some of the first and second end forms 46 and 60. In one modification, step d) heats the first and second end forms 46 and 60 to a semi-fused state and deformingly eliminates the first recess 54 bringing the atoms of the deformingly contacting portions of the first and second end forms 46 and 60 into close contact for an improved solid state weld. In one utilization, there is included the step of disposing first and second electrodes 62 and 64 as shown, wherein step d) includes relatively moving the first electrode 62 toward the second electrode 64.

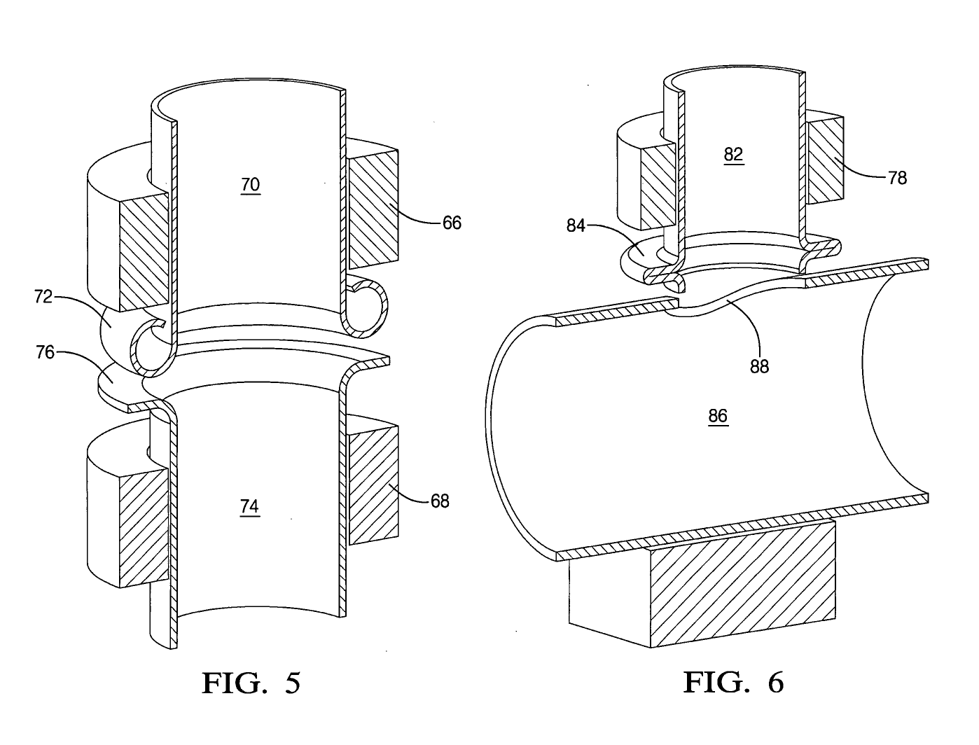

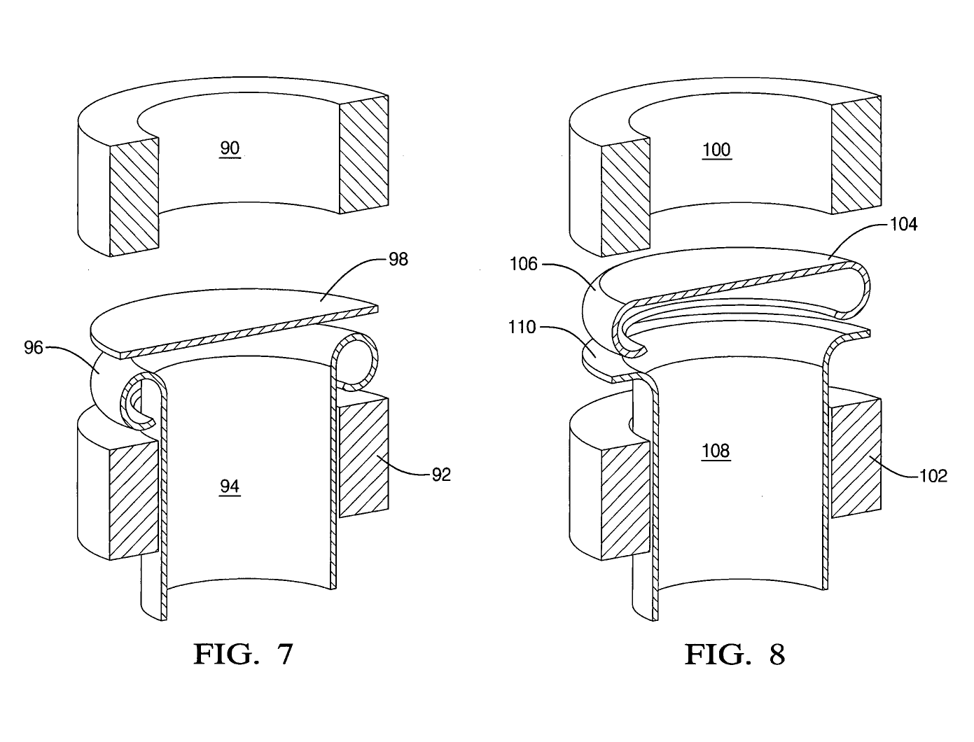

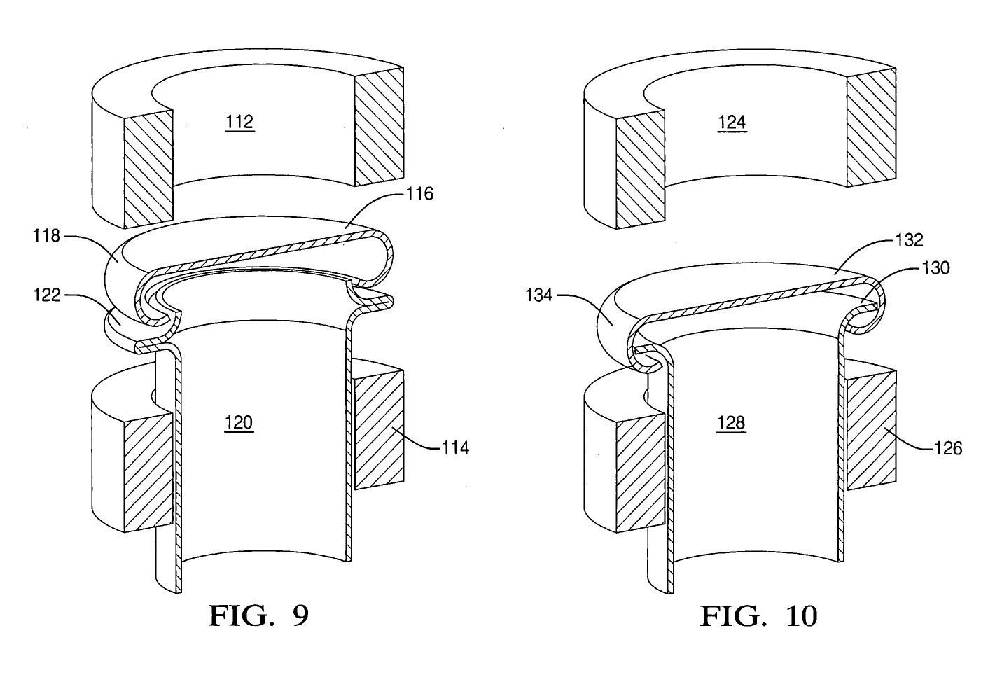

Other embodiments, without limitation, of first tubes and members which can be used in the performance of the third and/or fourth method are shown in FIGS. 5-10. In the embodiment of FIG. 5 there are shown two electrodes 66 and 68, a first tube 70 having an outwardly-scrolled-back end form 72, and a tubular member 74 having an outwardly-transversely-flanged end form 76. In the embodiment of FIG. 6, there are shown two electrodes 78 and 80, a first tube 82 having an outwardly-transversely-folded end form 84, and a second tube 86 having a through hole 88. In the embodiment of FIG. 7, there are shown two electrodes 90 and 92, a first tube 94 having an outwardly-scrolled-back end form 96, and an end cap plate 98. In the embodiment of FIG. 8, there are shown two electrodes 100 and 102, an end cap 104 having a turned-in annular edge 106, and a first tube 108 having an outwardly-transversely-flanged end form 110. In the embodiment of FIG. 9, there are shown two electrodes 112 and 114, an end cap 116 having a turned-in annular edge 118, and a first tube 120 having an outwardly-transversely-folded end form 122. In the embodiment of FIG. 10, there are shown two electrodes 124 and 126, a first tube 128 having an outwardly-transversely-flanged end form 130, and an end cap 132 having an edge 134 which is turned-in and surrounds the end form 130.

Several benefits and advantages are derived from one or more of the methods of the invention. Welding using electric current is less expensive than gas metal arc welding or friction welding. Welding using electric current also has a shorter cycle time between welds than gas metal arc welding or friction welding. Deformation welding allows solid state welds of dissimilar materials without the formation of brittle intermetallic compounds.

The foregoing description of several methods of the invention has been presented for purposes of illustration. It is not intended to be exhaustive or to limit the invention to the precise procedures or precise forms disclosed, and obviously many modifications and variations are possible in light of the above teaching. It is intended that the scope of the invention be defined by the claims appended hereto.

1. A method for welding comprising the steps of:
a) obtaining a first member including a first extrusion having a first through hole;
b) obtaining a second member having a second extrusion having a second through hole;
c) obtaining a first electrode having a first-electrode portion;
d) obtaining a second electrode having a second-electrode portion;
e) disposing the second member to have the second extrusion nest in the first through hole against the first extrusion;
f) disposing the first electrode to have the first-electrode portion nest in the second through hole against the inside of the second extrusion;
g) disposing the second electrode to have the second-electrode portion contact the outside of the first extrusion; and
h) creating a welding current path through the first electrode, the second extrusion, the first extrusion, and the second electrode to create a weld zone which includes at least some of the first and second extrusions.

2. The method of claim 1, wherein step h) also includes relatively moving the first and second electrodes to relatively move the first extrusion deformingly against the second extrusion.

3. A method for welding comprising the steps of:
a) obtaining a tube including a sidewall having a first extrusion having a first through hole;
b) obtaining a member having a second extrusion having a second through hole;
c) obtaining a first electrode having a first-electrode portion;
d) obtaining a second electrode having a second-electrode portion;
e) disposing the member from outside the tube to have the second extrusion nest in the first through hole against the first extrusion;
f) disposing the first electrode from outside the tube to have the first-electrode portion nest in the second through hole against the inside of the second extrusion;
g) disposing the second electrode to have the second-electrode portion contact the outside of the first extrusion from inside the tube; and
h) creating a welding current path through the first electrode, the second extrusion, the first extrusion, and the second electrode to create a weld zone which includes at least some of the first and second extrusions.

4. The method of claim 3, wherein step h) includes relatively moving the first and second electrodes to relatively move the first extrusion deformingly against the second extrusion.

5. The method of claim 4, wherein the tube is a substantially rectangular tube.

6. The method of claim 4, wherein the member is a bracket which includes a plate and the second extrusion, and wherein the second extrusion extends substantially perpendicular from the plate.

7. The method of claim 4, wherein the tube has a centerline, and wherein the first and second extrusions are substantially coaxially aligned perpendicular to the centerline.

8. The method of claim 4, wherein the member is chosen from the group consisting of a bracket, a gusset, a hanger, a heat shield, and an impact shield.

9. The method of claim 4, wherein in step f) the first electrode portion is disposed in full circumferential contact with the inside diameter of the second extrusion.

10. The method of claim 9, wherein in step g) the second electrode portion is disposed in full circumferential contact with the outside diameter of the first extrusion.

11. The method of claim 10, wherein the weld zone is an annular weld zone.

12. The method of claim 4, wherein step h) is performed without the use of filler material.

13. The method of claim 4, wherein the tube and the member are made of dissimilar materials, and wherein step h) heats at least some of the first and second extrusions to a semi-fused state.

14. The method of claim 4, wherein the tube and the member are made of similar materials, and wherein step h) heats at least some of the first and second extrusions to a fused state.

15. A method for welding comprising the steps of:
a) obtaining a first tube having a first end form;
b) obtaining a member having first and second portions;
c) disposing the first tube and the member with the first end form contacting the first portion while leaving a first recess between the first end form and the second portion;
d) creating a welding current path through the first end form and the member and relatively moving the first end form deformingly against the member to eliminate the first recess and create a weld zone which includes at least some of the first end form and at least some of the member.

16. The method of claim 15, wherein the member is chosen from the group consisting of a second tube having a second end form for contacting the first end form, a second tube including a sidewall having a through hole for receiving a portion of the first end form, a plate, an end cap having an annular scrolled edge, and wherein the first end form is chosen from the group consisting of an outwardly-transversely-flanged first end form, and an outwardly-transversely folded first end form.

17. A method for welding comprising the steps of:
a) obtaining a first tube having an outwardly-scrolled-back first end form;
b) obtaining a member having first and second portions;
c) disposing the first tube and the member with the first end form contacting the first portion while leaving a first recess between the first end form and the second portion;
d) creating a welding current path through the first end form and the member and relatively moving the first end form deformingly against the member to eliminate the first recess and create a weld zone which includes at least some of the first end form and at least some of the member.

18. The method of claim 17, wherein the member is chosen from the group consisting of a second tube having a second end form for contacting the first end form, a second tube including a sidewall having a through hole for receiving a portion of the first end form, a plate, an end cap having an annular scrolled edge.

19. The method of claim 15, wherein the member is a second tube having a second end form, and wherein the first and second portions are first and second portions of the second end form.

20. The method of claim 19, wherein step d) creates a welding current path through the first and second end forms and relatively moves the first end form deformingly against the second end form to eliminate the first recess and create the weld zone, wherein the weld zone includes at least some of the first and second end forms.
